(19) United States
(12) Patent Application Publication
(10) Pub. No.: US 2026/0103112 A1
(43) Pub. Date: Apr. 16, 2026

(54) VEHICLE VIDEO RECORDING DEVICE AND METHO OF CONTROLLING THE SAME

(71) Applicants: Hyundai Motor Company, Seoul (KR); Kia Corporation, Seoul (KR)

(72) Inventors: Jeong Muk Kang, Hwaseong-Si (KR); Sung Hwan Jun, Hwaseong-Si (KR); Seok Ju Yeom, Hwaseong-Si (KR); Dong Hyuk Jeong, Hwaseong-Si (KR); Kyoung Jun Kim, Hwaseong-Si (KR)

(21) Appl. No.: 19/249,176

(22) Filed: Jun. 25, 2025

(30) Foreign Application Priority Data
Oct. 14, 2024 (KR) 10-2024-0139678

(51) Int. Cl. B60L 58/13; B60L 1/00; B60L 50/60; B60L 58/22; H04N 5/77; H04N 23/65

(52) U.S. Cl. CPC B60L 58/13; B60L 1/00; B60L 50/60; B60L 58/22; H04N 5/77; H04N 23/65

(57) ABSTRACT

An apparatus for a vehicle may comprise a first battery, a second battery, a camera configured to record surroundings of the vehicle, and a control circuit. The control circuit may be configured to receive first state of charge (SOC) information of the first battery and second SOC information of the second battery, select, based on the first and second SOC information, one of the first battery and the second battery, and control, based on the selected battery, the camera to record the surroundings of the vehicle.

### CROSS-REFERENCE TO RELATED APPLICATION

This application claims the benefit of priority to Korean Patent Application No. 10-2024-0139678, filed in the Korean Intellectual Property Office on Oct. 14, 2024, the entire contents of which are hereby incorporated by reference.

### TECHNICAL FIELD

The present disclosure relates to a vehicle video recording device and a method of controlling the video recording device.

### BACKGROUND

The matters described in this Background section are only for enhancement of understanding of the background of the disclosure, and should not be taken as acknowledgment that they correspond to prior art already known to those skilled in the art.

A vehicle video recording device is a device that records video of, for example, a vehicle driving or parking.

The vehicle video recording device may also be referred to as a driving video recording device because it is used to acquire images of accidents and the like while the vehicle is driving.

To acquire video, the vehicle video recording device may include a controller, a memory for storing video, and a camera for recording video.

The vehicle video recording device may store video of the surroundings of a vehicle while driving, along with driving data of the vehicle at the time, and if a predefined event is detected, even while parked, may record video based on preconfigured settings.

The vehicle video recording device, initially provided as an external device referred to as a “black box” (or dash cam), may be provided by being built into a vehicle before released from the factory.

Such a built-in camera may have an advantage over an external camera in that it has access to the driving data of a host vehicle and interworks with other controllers, and its use is thus expected to increase.

The vehicle video recording device may perform continuous recording and event recording while driving and parking, and may interwork with an audio video navigation (AVN) system to facilitate system settings and stored image viewing.

Although there is a demand for parking recording for a continued long time from customers who do not drive their vehicles daily or leave them parked for extended periods, a parking recording time provided by the vehicle video recording device may fail to meet this demand. Therefore, a vehicle video recording device with extended parking recording time is considered to better accommodate long-duration parking scenarios.

### SUMMARY

According to the present disclosure, an apparatus for a vehicle, the apparatus may comprise, a first battery, a second battery, a camera configured to record surroundings of the vehicle, and a control circuit configured to, receive first state of charge (SOC) information of the first battery and second SOC information of the second battery, select, based on the first and second SOC information, one of the first battery and the second battery, and control, based on the selected battery, the camera to record the surroundings of the vehicle.

The apparatus, wherein the first battery may comprise, a parking-lithium battery configured to be charged by power supplied by the second battery or a third battery, and wherein the parking-lithium battery is dedicated for recording the surroundings of the vehicle.

The apparatus, wherein the second battery may comprise, a battery having an output voltage in a range from 11 volts to 13 volts.

The apparatus may further comprise a third battery, wherein the third battery may comprise, a main battery configured to provide drive power to the vehicle.

The apparatus, wherein the control circuit is further configured to, use, based on the first SOC information, the second battery to supply power to the camera, wherein the first SOC information indicates that an SOC of the first battery is less than or equal to a first set value, and charge, based on the second SOC information, the second battery using power from a third battery, wherein the second SOC information indicates that an SOC of the second battery is less than or equal to a second set value.

The apparatus, wherein the control circuit is further configured to, charge, based on completion of charging the second battery using power from a third battery, the first battery using power from the second battery.

The apparatus, wherein the control circuit is further configured to, charge the second battery until the second SOC information indicates that an SOC of the second battery reaches a third set value.

The apparatus, wherein the control circuit is further configured to, determine, based on the first SOC information after completion of charging the second battery, an available recording time, wherein the first SOC information indicates an SOC of the first battery.

The apparatus, wherein the control circuit is further configured to, control, based on the available recording time, the camera to perform recording using power from one of the first battery and the second battery.

The apparatus, wherein the control circuit is further configured to, obtain, via a local interconnect network communication, an SOC value of the first battery.

According to the present disclosure, an apparatus for a vehicle, the apparatus may comprise, a first battery, a second battery, a camera configured to record surroundings of the vehicle, and a control circuit configured to, control the camera to start recording using power from the first battery, and charge, based on a state of charge (SOC) of the first battery falling below a set value, the first battery using power from the second battery.

The apparatus, wherein the first battery may comprise, a battery having an output voltage in a range from 11 volts to 13 volts.

The apparatus, wherein the second battery may comprise, a main battery configured to provide drive power to the vehicle.

The apparatus, wherein the control circuit is further configured to, obtain an SOC value of the first battery by receiving a controller area network (CAN) signal from a central communication circuit.

According to the present disclosure, a method performed by an apparatus for a vehicle, the method may comprise, determining a state of charge (SOC) of a first battery and an SOC of a second battery, controlling a camera of the vehicle to start recording using power from the first battery, controlling, based on the SOC of the first battery being less than or equal to a first set value, power from the second battery to be supplied to the camera, charging, based on the SOC of the second battery being less than or equal to a second set value, the second battery using power from a third battery, charging the first battery using power from the second battery, based on completion of charging the second battery and based on the SOC of the first battery, determining an available recording time, and controlling, based on the available recording time, the camera to perform recording using power from one of the first battery and the second battery.

The method, wherein the first battery may comprise, a parking-lithium battery configured to be charged by power supplied by the second battery or the third battery, and wherein the parking-lithium battery is dedicated for video recording.

The method, wherein the second battery may comprise, a battery having an output voltage in a range from 11 volts to 13 volts.

The method, wherein the third battery may comprise, a main battery configured to provide drive power to the vehicle.

The method, wherein the charging the second battery using power from the third battery may comprise, charging the second battery until the SOC of the second battery reaches a third set value.

According to the present disclosure, a method performed by an apparatus for a vehicle, the method may comprise, receiving state of charge (SOC) information of a plurality of batteries of the vehicle, selecting a battery from among the plurality of batteries based on the SOC information, controlling a camera to perform recording surroundings of the vehicle using power from the selected battery, switching, based on the SOC of the selected battery falling below a threshold, to another battery of the plurality of batteries to continue the recording, and controlling, based on a SOC of one battery of the plurality of batteries being below a charge threshold, charging of the one battery using power from another battery of the plurality of batteries.

The effects of the present disclosure are not limited to those described above, and other effects not described above will be apparent to those having ordinary skill in the art from the following description.

### BRIEF DESCRIPTION OF THE DRAWINGS

FIG. 1 shows an example of a vehicle video recording device, according to one example of the present disclosure.

FIG. 2 shows an example of a parking recording time update operation of a vehicle video recording device powered by a first battery and a second battery, according to one example of the present disclosure.

FIG. 3 shows an example of a parking recording time update operation of a vehicle video recording device powered by a second battery, without a first battery, according to one example of the present disclosure.

FIG. 4 shows an example of a parking recording time update operation of a vehicle video recording device powered by a first battery and a second battery, according to one example of the present disclosure.

FIG. 5 shows an example of a parking recording time update operation of a vehicle video recording device powered by a second battery, without a first battery, according to one example of the present disclosure.

### DETAILED DESCRIPTION

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.” For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

The processor may be electrically connected to the memory, and the processor may load data from and record data in the memory. The memory and the processor may be integrated or may be physically separated.

Hereinafter, various examples of the present disclosure will be described in detail with reference to the accompanying drawings.

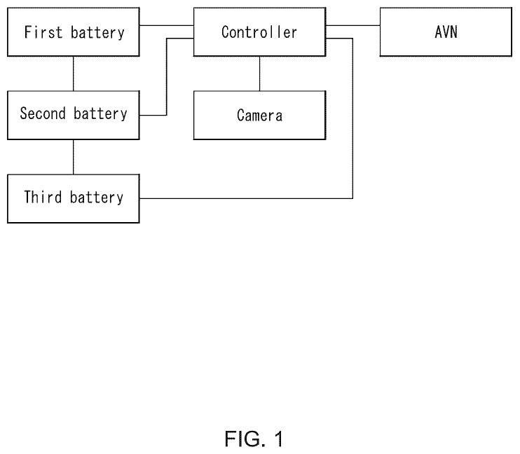

FIG. 1 shows an example of a video recording device for a vehicle according to one example of the present disclosure (e.g., applicable to electric vehicles, hybrid vehicles, or plug-in hybrid vehicles equipped with parking surveillance features, etc.).

Referring to FIG. 1, a video recording device for a vehicle (or simply referred to herein as a “vehicle video recording device”), according to one example of the present disclosure, may include a first battery 10, a second battery 20, a third battery 30, a controller 40, a camera 50, and an audio video navigation (AVN) system 60 (e.g., a central in-vehicle infotainment system that allows user configuration, real-time monitoring, or video playback, etc.).

The first battery 10 may include a parking-lithium battery module (P-LBM) that may receive power from the second battery 20 to be charged therewith and may provide power to the vehicle video recording device while the vehicle is parked (e.g., during extended parking in an airport lot, a weekend trip, or long-term storage, etc.).

The second battery 20, which is a battery with a 12-volt (V) or a working range of 11-volt to 13-volt (V) that may be charged by receiving power from the third battery 30, may include an electric vehicle absorbent glass mat (eAGM) battery, and may provide power to the vehicle video recording device while the vehicle is parked (e.g., overnight, in urban settings, or if the P-LBM is unavailable, etc.).

The third battery 30, which is a high-voltage battery that provides power to drive an electric motor that generates power for an electric vehicle, may be charged while the vehicle is traveling and may provide power to various electronic components of the vehicle (e.g., infotainment systems, HVAC, or powertrain control units, etc.).

The electric vehicle described herein may also include a hybrid vehicle using power from both an electric motor and an internal combustion engine, in addition to a vehicle driven solely by the power of the electric motor (e.g., battery electric vehicles (BEVs), plug-in hybrid electric vehicles (PHEVs), or hybrid electric vehicles (HEVs), etc.).

If charging the second battery 20 with the third battery 30, a low direct current to direct current (DC-DC) converter (LDC) provided in the vehicle may be used to convert a high voltage output from the third battery 30 into a low voltage of 12V and provide the voltage to charge the second battery 20 until it reaches a state of charge (SOC) for completion of auxiliary charging (or simply referred to herein as “auxiliary charging completion SOC”) (e.g., 92%, 95%, or another manufacturer-defined target SOC, etc.). The LDC may be integrated into the vehicle's power distribution circuitry or implemented as a stand-alone circuit, depending on vehicle architecture (e.g., centralized, zonal, or modular platforms, etc.).

The controller 40 may acquire an SOC value of the first battery 10 via a Local Interconnect Network (LIN) communication with the first battery 10. The controller 40 may also receive SOC information from the second battery 20 via a controller area network (CAN) signal from a central communication unit (CCU) (not shown).

Based on such SOC information of the first battery 10 and the second battery 20 acquired as described above, the controller 40 may select one battery from between the first battery 10 and the second battery 20 to receive power, and instruct the camera 50 to perform recording (e.g., during parking mode, surveillance triggers, or upon motion detection, etc.).

The controller 40 may also instruct initiation of the recording with power received from the first battery 10, and provide an instruction to receive power from the second battery 20 in response to an SOC value of the first battery 10 being less than or equal to a set value and to auxiliary-charge the second battery 20 with the third battery 30 in response to an SOC value of the second battery 20 being less than or equal to another set value. (e.g., 5% for the first battery and 80% for the second battery, etc.). These thresholds may be predefined, dynamically adjusted, or set by user preferences through the AVN system (e.g., based on energy-saving mode, extended surveillance mode, or default factory settings, etc.).

Although such an instruction for auxiliary-charging the second battery 20 with the third battery 30 is omitted from the drawing, the controller 40 may transmit, to a vehicle controller (e.g., vehicle control unit (VCU)), a signal that requests battery auxiliary-charging, and the vehicle controller that has authorized the signal may instruct auxiliary-charging of the second battery 20 while discharging power stored in the third battery 30 into the second battery 20 (e.g., during deep parking discharge, emergency operation, or long-duration recording, etc.).

The controller 40 may also instruct the second battery 20 to auxiliary-charge the first battery 10 while the third battery 30 is auxiliary-charging the second battery 20. In this case, auxiliary-charging the second battery 20 with the third battery 30 may include charging the second battery 20 until the SOC value of the second battery 20 reaches the set value (e.g., 93% SOC, a programmable recharge threshold, or a vehicle-specific target, etc.).

If auxiliary-charging the second battery 20 is completed, the controller 40 may determine an available recording time by checking the SOC of the first battery 10, and may provide an instruction to perform the recording by receiving power from one selected from between the first battery 10 and the second battery 20 based on the available recording time (e.g., 5 hours, 15 hours, or up to 120 hours, etc.).

The camera 50 may include, but is not necessarily limited to, a front camera and a rear camera. The front camera may be installed to capture an image of an area before the vehicle, and the rear camera may be installed to capture an image of an area behind the vehicle (e.g., driveway entrance, parking lot lanes, or street-side surroundings, etc.).

For example, the front camera may be mounted on a windshield in the vehicle cabin near a rearview mirror, and the rear camera may be mounted on a rear window or rear bumper of the vehicle cabin.

The front camera and the rear camera may support an image quality of any one of high definition (HD), full HD (FHD), and quad HD (QHD), for example. It should be appreciated that the front camera and the rear camera need not be of the same image quality and may use a camera for an advanced driver assistance system (ADAS) of the vehicle (e.g., lane departure warning, pedestrian detection, or traffic sign recognition, etc.).

The camera 50 may have an aperture value of F2.0 or less, preferably F1.6 or less. The lower aperture value may allow more light to be collected, facilitating brighter recording. In addition, an image tuning technique may be applied to minimize noise and light loss, facilitating clear recording in dark environments (e.g., underground parking garages, night streets, or shaded alleys, etc.).

The AVN system 60 may be communicatively connected to the controller 40 via the vehicle controller or directly connected to the controller 40, and the screen of the AVN system 60 may function as a user interface (UI) for receiving various setup parameters of the vehicle video recording device from a user (e.g., setting parking duration, toggling battery usage mode, or selecting video quality, etc.).

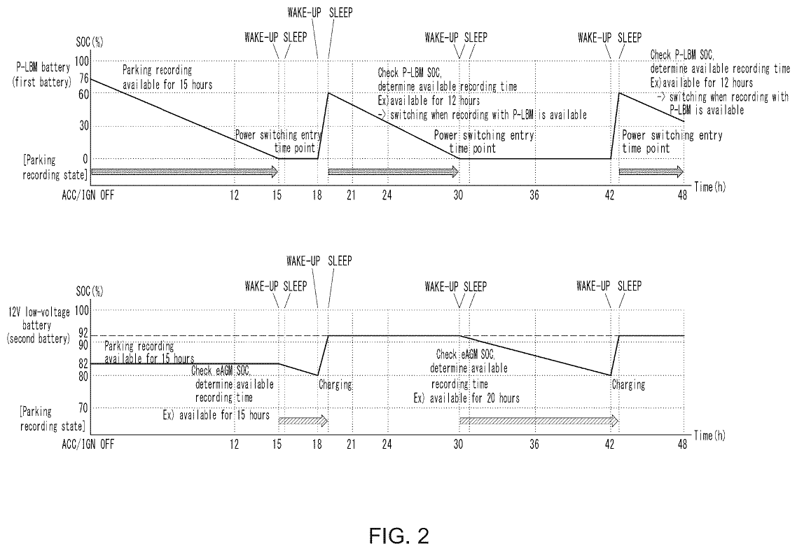

FIG. 2 shows an example of a parking recording time update operation of a vehicle video recording device powered by a first battery and a second battery, according to one example of the present disclosure (e.g., in electric vehicle platforms that include both a P-LBM and a 12V eAGM battery, etc.).

Referring to FIG. 2, the first battery 10 is illustrated as a P-LBM and the second battery 20 is illustrated as an eAGM. A recording time of the vehicle video recording device may be set to 120 hours, and an available recording time for parking (also “available parking recording time” herein) may be determined based on the initial SOC of the first battery 10 (e.g., P-LBM) and the second battery 20 (e.g., eAGM) (e.g., based on SOC levels such as 70% for the P-LBM and 85% for the eAGM, etc.). FIG. 2 illustrates an example case where the available parking recording time is 15 hours based on the initial SOC of the first battery 10 (P-LBM) and the second battery 20 (eAGM). If the initial SOC of the first battery 10 and the second battery 20 allow for 15 hours of recording, the vehicle video recording device may start parking recording by receiving power from the first battery 10. Then, if the SOC of the first battery 10 is less than or equal to a set value (e.g., 5% or less, or if the remaining available recording time is less than 1 hour, etc.), the vehicle video recording device may switch to the second battery 20 and perform parking recording with power from the second battery 20. However, if the available recording time of the second battery 20 does not meet a threshold value e.g., due to low SOC, degraded battery health, or recent usage history, etc.), the vehicle video recording device may not switch to the second battery 20 and may end the recording as it is. When performing the recording with the second battery 20, which is a 12V low-voltage battery, if the SOC value of the second battery 20 falls below a set value (e.g., 80% or less, such as during extended recording or multiple activation cycles, etc.), the second battery 20 that is the 12V low-voltage battery may be charged using a high-voltage battery auxiliary-charging function of the third battery 30 (e.g., triggered automatically via LDC operation if enabled in vehicle settings, etc.). In this case, the second battery 20 may be used to auxiliary-charge the first battery 10, and once the SOC of the first battery 10 is replenished, the parking recording may be resumed using power supplied from the first battery 10. The auxiliary-charging may continue until the SOC value of the second battery 20 that is the 12V low-voltage battery is greater than or equal to the set value (e.g., 92%, or a programmable threshold defined by the vehicle manufacturer, etc.), and when the auxiliary-charging is completed, the parking recording may continue using the power of the first battery 10 (e.g., P-LBM). This process may be repeated multiple times (e.g., up to 10 or more recharge cycles, depending on vehicle settings, user preference, or environmental conditions, etc.) until a target recording time is met.

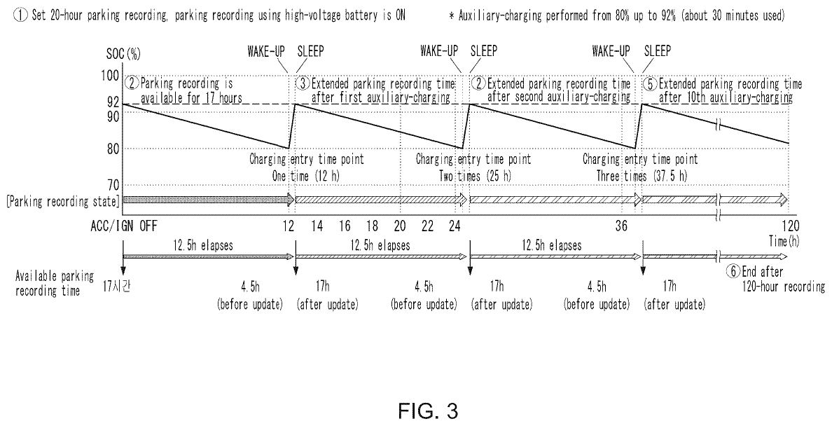

FIG. 3 shows an example of a parking recording time update operation of a vehicle video recording device powered by a second battery, without a first battery, according to one example of the present disclosure (e.g., in configurations that exclude a dedicated auxiliary battery such as a P-LBM, etc.).

FIG. 3 illustrates an example operation situation \textcircled{1} where a recording time of the vehicle video recording device is set to 20 hours and parking recording using a high-voltage battery is turned on. The vehicle video recording device may receive B+ power from the second battery 20 that is a 12V low-voltage battery and perform parking recording \textcircled{2}, and if an SOC of the second battery 20 that is the 12V low-voltage battery falls below a set value (e.g., 80% or less, such as after prolonged idle time, cold weather discharge, or high camera load, etc.), the third battery 30 that is a high-voltage battery may auxiliary-charge the second battery 20 until the SOC is greater than or equal to the set value (e.g., 92% or more, depending on predefined charge thresholds or user settings, etc.). The auxiliary-charging may use about 30 minutes, for example (e.g., depending on vehicle type, ambient temperature, or battery health, etc.). It should be apparent to those skilled in the art that the recording time, the SOC value for auxiliary-charging, and the like described herein are provided only as examples and may be used in various forms (e.g., user-defined settings, adaptive thresholds, or region-specific regulations, etc.). Referring to FIG. 3, it may be verified that the recording may continue until a target recording time (e.g., 120 hours, or 5 full days of surveillance, etc.) by continuously extending the parking recording time while the third battery 30 that is the high-voltage battery is auxiliary-charging the second battery 20 that is the 12V low-voltage battery up to 10 times (\textcircled{3} to \textcircled{5})(e.g., in cycles triggered by SOC drop, event-based wake-ups, or recording duration limits, etc.).

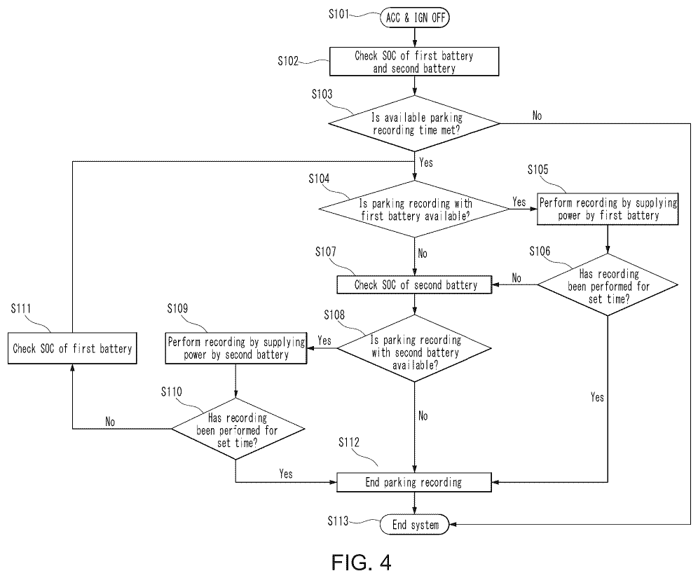

FIG. 4 shows an example of a parking recording time update operation of a vehicle video recording device powered by a first battery and a second battery, according to one example of the present disclosure (e.g., a system installed in EVs using a P-LBM and a 12V eAGM for extended recording operations, etc.).

Referring to FIG. 4, in step S101, when an accelerator (ACC) and vehicle start are turned off, the vehicle may enter a parking mode (e.g., after the ignition is turned off in a garage, at a public charging station, or in an outdoor parking lot, etc.). In step S102, the controller 40 may check SOC values of the first battery 10 and the second battery 20. In step S103, it may then determine an available parking recording time based on the respective SOC values (e.g., based on historical discharge data, preset thresholds, or real-time system parameters, etc.). If the available parking recording time meets a threshold, it may check whether the parking recording is available with the power of the first battery 10 in step S104, and may end the parking recording if the available parking recording time does not meet the threshold in step S113 (e.g., due to both batteries having insufficient charge for the desired duration, etc.).

If the parking recording is available by checking whether the parking recording is available with the power of the first battery 10 in step S104, it may perform the parking recording by drawing power from the first battery 10 in step S105, and if the parking recording is not available with the power of the first battery 10, it may check the SOC of the second battery 20 in step S107 (e.g., in cases where the P-LBM SOC is too low for continued operation, etc.).

The vehicle video recording device may perform the parking recording by receiving power from the first battery 10 in step S105, and may end the recording in step S112 after the recording has been performed for the set time in step S106 and may check the SOC of the second battery 20 in step S107 if the recording has not been performed for the set time (e.g., due to unexpected power draw, external motion triggers, or extended sensor activity, etc.).

After checking the SOC of the second battery 20 in step S107, the vehicle video recording device may perform the parking recording by receiving power from the second battery 20 if the parking recording is available (e.g., Yes in S108), and may end the parking recording in step S112 if the parking recording with the second battery 20 is not available (e.g., No in S108) (e.g., if SOC drops below a critical cutoff or if recharge from the high-voltage battery is disabled, etc.).

The vehicle video recording device may perform the recording with the power provided by the second battery 20 in step S109, and may end the recording in step S112 if the recording has been performed for the set time (e.g., Yes in S110) and may check an SOC of the first battery in step S111 if the recording has not been performed for the set time (e.g., No in S110)(e.g., due to early depletion of the second battery, an unexpected spike in power consumption, or extended sensor triggering, etc.). The vehicle video recording device may repeatedly perform the process described above until the target recording time is met by switching and supplying power while checking the SOC between the first battery 10 and the second battery 20 (e.g., enabling continuous recording for up to 120 hours by managing energy flow across cycles, etc.).

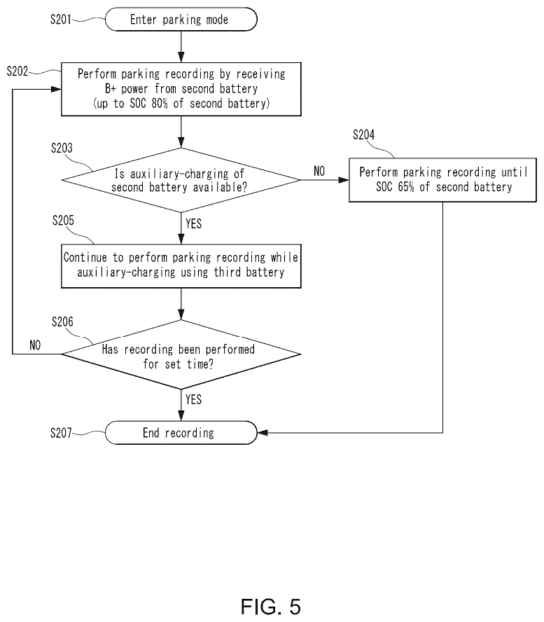

FIG. 5 shows an example of a parking recording time update operation of a vehicle video recording device powered by a second battery, without a first battery, according to one example of the present disclosure (e.g., in vehicle models that omit a dedicated P-LBM or in simplified system configurations, etc.).

Referring to FIG. 5, the vehicle may first enter a parking mode in step S201. Then, the vehicle video recording device may perform parking recording by receiving B+ power from the second battery 20 in step S202. In this case, the vehicle video recording device may perform the recording until the SOC of the second battery 20 reaches a predefined threshold (e.g., 80%). The SOC value is provided as an example and may vary depending on the situation (e.g., vehicle make, user-defined preferences, or ambient temperature, etc.). The vehicle video recording device may then check whether auxiliary-charging of the second battery 20 is available in step S203, and may continue performing the parking recording while auxiliary-charging the second battery 20 using the third battery 30 that is a high-voltage battery in step S205 if the auxiliary-charging is available (e.g., Yes in S203). Alternatively or additionally, it may perform the parking recording until the SOC of the second battery 20 reaches another predefined threshold (e.g., 65%) in step S204 if the auxiliary-charging of the second battery 20 is not available (e.g., No in S203). The SOC value described herein is provided as an example and may vary depending on the situation (e.g., due to battery age, software updates, or manufacturer presets, etc.).

The vehicle video recording device may continue performing the parking recording while performing auxiliary-charging using the third battery 30, and may end the recording in step S207 if the recording has been performed for the set parking recording time (e.g., Yes in S206), such as a user-selected period (e.g., 24 hours, 72 hours, or 120 hours, etc.). It may continue performing the operations until the recording is completed if the recording has not been performed for the set time (e.g., No in S206).

An example of the present disclosure is to provide a method of controlling a plurality of batteries to increase the parking recording time of a vehicle video recording device.

The technical challenges to be solved by the present disclosure are not limited to the ones described above, and other technical challenges not described above will become apparent to those having ordinary skill in the art from the following description.

According to at least one example of the present disclosure, a video recording device for a vehicle may include: a first battery; a second battery; a third battery; a camera configured to record a video of surroundings of the vehicle; and a controller, wherein the controller is configured to: receive state of charge (SOC) information of the first battery and the second battery, select one from between the first battery and the second battery based on the SOC information, and control the camera to perform recording.

In at least one example, the first battery may include a parking-lithium battery module (P-LBM) configured to be charged by power supplied by the second or the third battery and to be used only for the video recording device.

In at least one example, the second battery may include a 12-volt (12V) low-voltage battery of the vehicle.

In at least one example, the third battery may include a high-voltage main battery configured to provide drive power to the vehicle.

In at least one example, the controller may be configured to: use the second battery in response to an SOC of the first battery being less than or equal to a first set value, and charge the second battery with the third battery in response to an SOC of the second battery being less than or equal to a second set value.

In at least one example, the controller may be configured to: if charging the second battery with the third battery is completed, charge the first battery with the second battery.

In at least one example, the controller is further configured to charge the second battery until the SOC of the second battery reaches a third set value.

In at least one example, the controller may be configured to: if charging the second battery is completed, determine an available recording time based on the SOC of the first battery.

In at least one example, the controller may be configured to: control the camera to perform recording using power from one selected from between the first battery and the second battery based on the available recording time.

In at least one example, the controller may be configured to: acquire an SOC value of the first battery via local interconnect network (LIN) communication.

According to at least one example of the present disclosure, a video recording device for a vehicle may include: a second battery; a third battery; a camera configured to record a video of surroundings of the vehicle; and a controller, wherein the controller is configured to: control the camera to start recording using power of the second battery, and charge the second battery with the third battery if a state of charge (SOC) of the second battery falls below a set value.

In at least one example, the second battery may include a 12V low-voltage battery of the vehicle.

In at least one example, the third battery may include a high-voltage main battery configured to provide drive power to the vehicle.

In at least one example, the controller may be configured to acquire an SOC value of the second battery by receiving a controller area network (CAN) signal from a central communication unit (CCU).

According to at least one example of the present disclosure, a method of controlling a video recording device for a vehicle may include: determining an SOC of a first battery and an SOC of a second battery; controlling the camera to start recording using power from the first battery; controlling power from the second battery to be supplied to the camera if the SOC of the first battery is less than or equal to a first set value, and charging the second battery with the third battery if the SOC of the second battery is less than or equal to a second set value; charging the first battery with the second battery; if charging the second battery is completed, determining an available recording time based on the SOC of the first battery; and controlling the camera to perform recording using power from one selected from between the first battery and the second battery based on the available recording time.

In at least one example, the first battery may include a parking-lithium battery module (P-LBM) configured to be charged by power supplied by the second or the third battery and to be used only for the video recording device.

In at least one example, the second battery may include a 12V low-voltage battery of the vehicle.

In at least one example, the third battery may include a high-voltage main battery configured to provide drive power to the vehicle.

In at least one example, the auxiliary-charging of the second battery with the third battery may include charging the second battery until the SOC of the second battery reaches a third set value.

According to at least one example of the present disclosure, the parking recording time of a vehicle video recording device may be significantly increased.

It is apparent to one of ordinary skill in the art that the present disclosure may be embodied in other specific forms without departing from the spirit and essential features of the present disclosure. Accordingly, the above detailed description is not to be construed as limiting in any respect and should be considered exemplary. The scope of the present disclosure is to be determined by a reasonable interpretation of the appended claims, and all changes or modifications within the equivalents of the present disclosure are included in the scope of the present disclosure.

The method(s) according to examples described herein may be produced as a computer-executable program, and the program may be stored in a computer-readable recording medium. The computer-readable recording medium may include, for example, a read-only memory (ROM), a random-access memory (RAM), a compact disc ROM (CD-ROM), a magnetic tape, a floppy disk, an optical data storage device, a flash memory drive, or a solid-state drive (SSD), and the like, and may also be implemented in the form of carrier waves or wireless signals (e.g., Internet-based transmission, satellite communication, Bluetooth, or near-field communication (NFC), etc.).

The non-transitory computer-readable recording medium may be distributed across a networked computer system, such that computer-readable code may be stored and executed in a distributed manner. In addition, functional programs, code, and code segments for implementing the method(s) described herein may be readily inferred by programmers of ordinary skill in the art to which the present disclosure pertains.

It is apparent to a person of ordinary skill in the art that the present disclosure may be embodied in other specific forms without departing from the spirit and essential features of the present disclosure.

Accordingly, the above detailed description is not to be construed as limiting in any respect and should be considered illustrative. The scope of the present disclosure is to be determined by a reasonable interpretation of the appended claims, and all changes or modifications within the equivalents of the present disclosure are included in the scope of the present disclosure.

What is claimed:

1. An apparatus for a vehicle, the apparatus comprising:
a first battery;
a second battery;
a camera configured to record surroundings of the vehicle; and
a control circuit configured to:
receive first state of charge (SOC) information of the first battery and second SOC information of the second battery,
select, based on the first and second SOC information, one of the first battery and the second battery, and
control, based on the selected battery, the camera to record the surroundings of the vehicle.

2. The apparatus of claim 1, wherein the first battery comprises:
a parking-lithium battery configured to be charged by power supplied by the second battery or a third battery, and wherein the parking-lithium battery is dedicated for recording the surroundings of the vehicle.

3. The apparatus of claim 1, wherein the second battery comprises:
a battery having an output voltage in a range from 11 volts to 13 volts.

4. The apparatus of claim 1, further comprises a third battery, wherein the third battery comprises:
a main battery configured to provide drive power to the vehicle.

5. The apparatus of claim 1, wherein the control circuit is further configured to:
use, based on the first SOC information, the second battery to supply power to the camera, wherein the first SOC information indicates that an SOC of the first battery is less than or equal to a first set value, and
charge, based on the second SOC information, the second battery using power from a third battery, wherein the second SOC information indicates that an SOC of the second battery is less than or equal to a second set value.

6. The apparatus of claim 1, wherein the control circuit is further configured to:
charge, based on completion of charging the second battery using power from a third battery, the first battery using power from the second battery.

7. The apparatus of claim 1, wherein the control circuit is further configured to:
charge the second battery until the second SOC information indicates that an SOC of the second battery reaches a third set value.

8. The apparatus of claim 1, wherein the control circuit is further configured to:
determine, based on the first SOC information after completion of charging the second battery, an available recording time, wherein the first SOC information indicates an SOC of the first battery.

9. The apparatus of claim 8, wherein the control circuit is further configured to:
control, based on the available recording time, the camera to perform recording using power from one of the first battery and the second battery.

10. The apparatus of claim 1, wherein the control circuit is further configured to:
obtain, via a local interconnect network communication, an SOC value of the first battery.

11. An apparatus for a vehicle, the apparatus comprising:
a first battery;
a second battery;
a camera configured to record surroundings of the vehicle; and
a control circuit configured to:
control the camera to start recording using power from the first battery, and
charge, based on a state of charge (SOC) of the first battery falling below a set value, the first battery using power from the second battery.

12. The apparatus of claim 11, wherein the first battery comprises:
a battery having an output voltage in a range from 11 volts to 13 volts.

13. The apparatus of claim 11, wherein the second battery comprises:
a main battery configured to provide drive power to the vehicle.

14. The apparatus of claim 11, wherein the control circuit is further configured to:
obtain an SOC value of the first battery by receiving a controller area network (CAN) signal from a central communication circuit.

15. A method performed by an apparatus for a vehicle, the method comprising:
determining a state of charge (SOC) of a first battery and an SOC of a second battery;
controlling a camera of the vehicle to start recording using power from the first battery;
controlling, based on the SOC of the first battery being less than or equal to a first set value, power from the second battery to be supplied to the camera;
charging, based on the SOC of the second battery being less than or equal to a second set value, the second battery using power from a third battery;
charging the first battery using power from the second battery;
based on completion of charging the second battery and based on the SOC of the first battery, determining an available recording time; and
controlling, based on the available recording time, the camera to perform recording using power from one of the first battery and the second battery.

16. The method of claim 15, wherein the first battery comprises:
a parking-lithium battery configured to be charged by power supplied by the second battery or the third battery, and wherein the parking-lithium battery is dedicated for video recording.

17. The method of claim 15, wherein the second battery comprises:
a battery having an output voltage in a range from 11 volts to 13 volts.

18. The method of claim 15, wherein the third battery comprises:
a main battery configured to provide drive power to the vehicle.

19. The method of claim 15, wherein the charging the second battery using power from the third battery comprises:
charging the second battery until the SOC of the second battery reaches a third set value.
